(19) United States
(12) Patent Application Publication
(10) Pub. No.: US 2005/0028146 A1
(43) Pub. Date: Feb. 3, 2005

(54) Systems and methods for software and firmware testing using checkpoint signatures

(76) Inventor: Shawn G. Quick, Sacramento, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/632,423

(22) Filed: Aug. 1, 2003

(51) Int. Cl. G06F 9/44

(52) U.S. Cl. 717/130; 717/128

(57) ABSTRACT

A method for testing code comprises instrumenting code to output checkpoints at selected points during execution of the code on a processor device to derive individual test checkpoints, and generating a signature using the checkpoints.

### FIELD OF THE INVENTION

The present invention is generally related to software/firmware testing and specifically related to systems and methods for software and firmware testing using checkpoint signatures.

### DESCRIPTION OF THE RELATED ART

Forms of software tests known in the art include code coverage, measuring which instructions in a specific software binary that are executed when running certain tests or a group of tests, and test coverage, a measurement of what paths are executed when certain tests get executed. However, when testing high-end embedded server firmware, an operating system (OS) may not be running on the system under test. Once such a computer system has been initialized, the environment may still be very internal to the system, making it very difficult to get data out of the system. The embedded firmware does not have hardware available for its use. Therefore, problems arise with getting data about firmware code execution out of the system under test.

Existing tools are available for measuring code coverage, but they rely on an OS being available, which supplies file input/output, memory accesses and some type of console for the user to employ. In a high-end server firmware test environment these OS administered components are typically not available, especially early in execution of firmware code, before advance initialization. Problematically, a need exists to measure how much code is being executed during a test run and at the end of a qualification run provide an indication of paths through the code that have been taken.

Existing solutions have either tried to insert hardware into the system or have relied on getting positive results out of the system. Hardware such as a PromICE code coverage device may give true code coverage at the instruction level. However, such a device only monitors read only memory (ROM) accesses. Primary domain controllers (PDCs), employed by firmware, may execute, at least in part, from a relocated random access memory (RAM) image. In high-end server firmware about half of firmware instruction may be executed from RAM, and typically all OS accesses to the firmware are from RAM. As a further problem a PromICE device is typically unaware of multiple processor (MP) situations. Therefore, a PromICE device will not function properly when more than one processor has accessed a particular section of code. Due to PromICE lacking multiprocessor support, PromICE may, as a practical matter, only be used on a per cell basis in multi-nodal computer systems and only on development machines. A PromICE device is unable to discriminate between instruction fetch and data fetch functions. As a result any ROM relocation carried out by the firmware would cause an erroneous indication that the PromICE has provided complete coverage, particularly if the PromICE is not set up properly. Also, instruction caches cause coverage data integrity problems in such a test device. As a result, a sixty-four byte cache line would be marked as “covered” even though only a single instruction was executed from that cache line. PromICE may not be used to aid in debugging and root cause analysis as these functions are beyond existing PromICE device capabilities. Also, no method of ‘pass/fail’ based on coverage statistics is typically provided by such test devices.

Hardware such as PromICE is intrusive into the system. Another problem is that as binaries change, as software is changed to fix problems that have been found in previous tests, data from previous tests is not tied together in a meaningful manner. So the whole firmware suite needs to be retested. These devices do provide some information, but the information is so diverse and changes so quickly that it is not very useful.

Another manner for developing code coverage is to use a software based simulator that executes firmware code without the need of additional hardware. Again, this existing solution has the same problems as hardware, in that it only captures the results of instruction execution. It does not give an indication of which instructions executed or when the instructions executed, particularly once changes are made to the software. Whereas a simulator is typically unable to easily map specific tests to specific coverage reports, test suite targeting typically requires manual manipulation of the simulator. Another problem with a simulator is that the simulator cannot exactly replicate the actual hardware that it is trying to simulate. Because of real-time constraints on hardware, the software cannot execute fast enough for a truly accurate simulation. Thus, such a simulation run is not a valid one-to-one comparison. Entire qualification runs need to be carried out on a simulator. Often such simulations runs are not feasible. Furthermore, ROM/RAM accesses must be merged for simulation.

Another existing method to provide code coverage is to use a third party code coverage tool. These tools typically require a large amount of back-end support, such as a file system, OS, memory initialization, and the like, that are not available during firmware testing. To use a third party code coverage tool, code must be instrumented by the tool, adding considerable overhead. Most tools can only instrument ‘C’ language code and not assembly language code. Developers using such code coverage tools must weed through this code while maintaining integrity of the code. Instrumentation may also change the way code executes or, at the very least, add cost to writing code when dealing with machine state finalization of code. Code coverage tools are not particularly useful for firmware debugging as they are targeted at application development where an OS, with RAM, storage and I/O functionality, is present. Also, a portion of firmware runs even when there is no boot stack yet, much less an operating OS required by such a code coverage tool.

Another disadvantage of existing code coverage and test coverage tools in general is that they are tied to an individual binary. Those binaries have hard coded addresses and memory references. Resultantly, these tools may only report that an address was detected or a specific instruction was executed at a specific address. If the binary changes in any way, if one byte or one word is added to the binary, all the addresses may be shifted down, the data that has been previously collected on a qualification becomes invalid, and a whole new set of tests must be run. This is particularly problematic in a firmware development environment, because ROMs may change often as qualification tests are carried out. Resultantly, new ROM “rollouts” cause previously collected data to become obsolete resulting in problems that require additional development of tools to align data collected from different ROM binaries.

“Trace” commands and functionality or the like have been used by interpreted program languages, such as BASIC or Per1, to output a mapping of every line of a program that is executed. Therefore, turning on a “trace” function, such as through insertion of a “tron” command in a BASIC program slows execution of the program by a considerable factor. Compiled languages, such as languages that are converted to native machine code for use in firmware, typically do not have a “trace” mechanism.

### BRIEF SUMMARY OF THE INVENTION

An embodiment of a method for testing code comprises instrumenting code to output checkpoints at selected points during execution of the code on a processor device to derive individual test checkpoints, and generating a signature using the checkpoints.

An embodiment of a system for testing code comprises an under test processor based device executing the code, wherein the code is instrumented to output checkpoints at selected points during execution, the processor device adapted to output the checkpoints in a stream, and an external processor device receiving the output checkpoint stream and deriving a checkpoint signature for execution of the code from the stream.

An embodiment of a method for merging code from a source processor platform to a target processor platform comprises implementing the code to output checkpoints at selected points during execution of the code on a target processor platform to derive a stream of individual test checkpoints, generating an ordered signature using the checkpoints, and comparing the signature against an archived signature derived from successful execution of the code on a source processor platform.

### BRIEF DESCRIPTION OF THE DRAWINGS

FIG. 1 is a flow chart of an embodiment of a method for providing a checkpoint signature;

FIG. 2 is a flow chart of an example program adapted to output the present test checkpoint signatures;

FIG. 3 is a diagrammatic illustration of a test system employing an embodiment of the present invention; and

FIG. 4 is a flow chart of an embodiment of code migration using testing checkpoint signatures.

### DETAILED DESCRIPTION

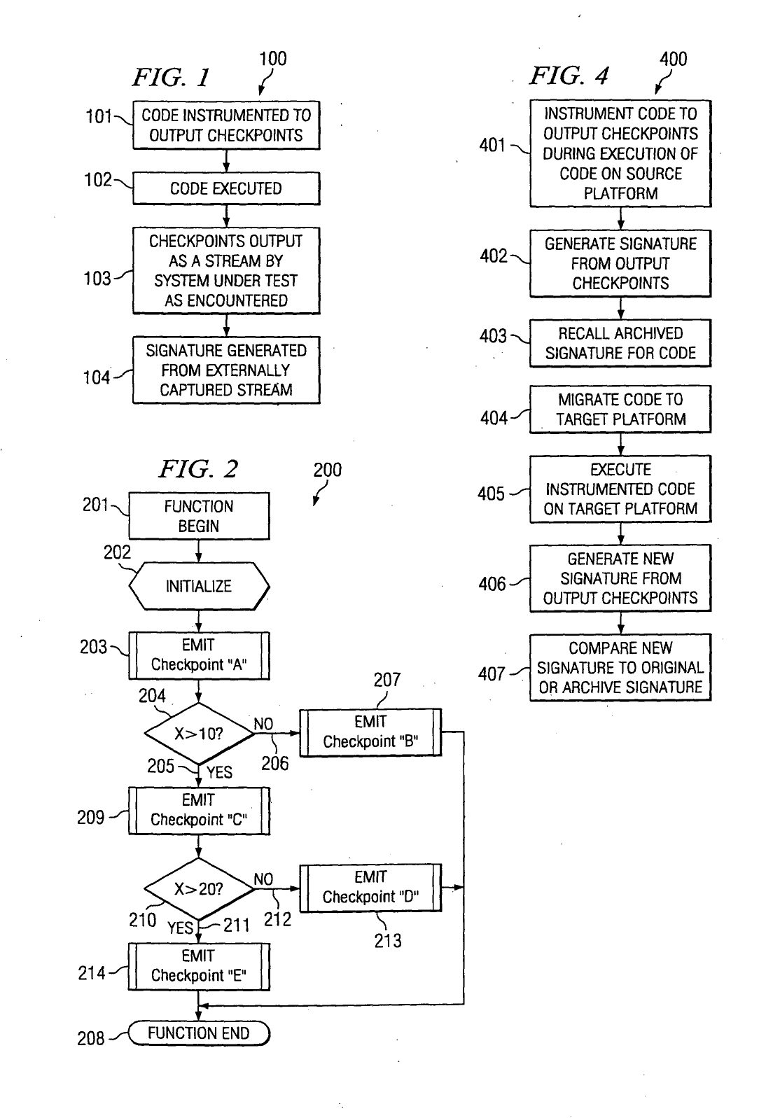

The present invention provides systems and methods for developing and using software and firmware testing checkpoint signatures. FIG. 1 is a flow chart of an embodiment of a method 100 for providing a checkpoint signature. In accordance with the present invention, code is instrumented to output checkpoints or some internal designations, such as numbers, that are individually unique, at selected points throughout the executing binary, at 101. According to embodiments of the present invention, only one place in the code actually outputs a specific designation such as a number. As code executes at 102 and these checkpoints are reached, these numbers or other designations are produced in a stream at 103. In other words, the first checkpoint to be reached sends out a first number or designation, and a second checkpoint sends out the second number or designation and so on. Thusly, the code generates a unique signature, or map, of the software that may be externally captured at 104 as a signature.

Once that data has been captured, analysis may be carried out with a knowledge of how the checkpoints map back to the software being tested. The present invention facilitates the use of garnered signature data to map execution paths to tests, or to examine small sections of larger signatures for individual functions, lines, tests, code, or programs. The signatures may be used to measure paths executed and what tests carried out what functions. If the actual data, or signature, generated from a specific test is compared against an expected signature of the same test in a passing case, immediate pass/fail criteria may be determined. Additionally, as code is added, modified or removed from one revision to the next, the signature may also change correspondingly, providing an indication that the test process and/or documentation is out of date.

The present invention provides numerous system code coverage related benefits. The present invention may be used in conjunction with running firmware or other code on actual hardware or under a software simulator device. Additionally, the present invention has very little overhead and allows the code under test to execute in near real-time. As a result, all the advantages of the simulator may be exploited in code development. Then the same tests and the same source code may be moved from the simulator environment to an actual hardware test environment.

Another code coverage related benefit is that checkpoint signatures may show execution paths and provide insight on code that has not been available previously. For example, the present invention enables matching actual software source code to tests that execute that code. When instrumenting code using the present invention, each function in the code might have a checkpoint installed at the beginning and at the end of the function. As a result, individual functions generate their own unique signature. So, a large stream of checkpoint data may be analyzed to find sub-signatures of each function to discern the order those functions were called, and map these function signatures back to the source code. Thusly, the present invention provides systems and methods to find out which functions are actually being executed in the code. This may be used to find “dead” code, code that never executes. On occasion, in complex code the tree of function calls gets very deep and it becomes difficult to ascertain everything the computer is doing at any given time. Resultantly, a fix that only changes a small section of code, and should not affect anything else, may break some code that was being executed at the point of the fix. Employing software signatures a developer may map function trees and thereby ascertain exactly what code is executing. So, when a fix is implemented in that code, the developer may avoid breaking the executing code. Additionally, software signatures may be used to verify that fixes are implemented correctly, and that signature calls to other code are still the same as they were originally.

Also beneficial to code coverage, checkpoints may be included in both normal code paths and error paths. In some cases existing software may detect an error within itself, or if something is wrong with the system. By having a signature generated for sections of code executed during error states, a system may be monitored for any time those sections of code have been executed. To monitor for error states a watch-list of signatures that indicate use of error paths through code may be generated and test output monitored for those signatures. If code is executing properly, these signatures are never seen. Additionally, checkpoints may be designed into code as it is written to ensure capture of all error cases. Therefore, the present invention not only helps developers qualify software, but it may also help the developers find the root cause of an error and may be used to help design and test new features being added to code.

Advantageously, every signature, whether it is a single checkpoint value or a large list of checkpoint values, may be broken down into sub-component parts which are specific instances of an execution path within the subject code and may represent test suites, individual tests, sections of code, functions, etc. An entire qualification run may generate a signature having a great number of data points, while a particular function may only generate a few data points, but those data points may be found many times in the large signature from a qualification run.

Firmware quality related benefits provided by the present invention include use to identify where software modifications have been made within code by knowing which checkpoints are affected by the modifications. Tests that are used to test that functionality may be rescheduled or formulated accordingly. In existing test environments, developers change code but really do not know which tests actually test or execute that code. With the present software checkpoint mechanism a map against previously run signatures indicate what code each test executes. Since each test has a signature, if code execution were to be changed around a particular checkpoint, then all tests that have that checkpoint in their signatures may be marked to be rerun.

Under existing systems and methods, code is designed, written and tested, in that order. Traditionally, there is very little pre-design, or very little design for tests in the system. Another advantage of the present systems and methods is that as developers code software, they can be thinking about places in the software where they may want to place checkpoints and write tests based on those checkpoints, as needed. Generally, when designing software, a developer knows where error cases are likely, and using the present invention, the developer may try to handle those cases in the code early in the code development process.

In accordance with the present invention signatures are not tied to any specific addresses in the binary. Therefore, since binaries may change, such as between qualification runs as discussed above, although the signatures might change slightly when code has changed, all the previous data is not lost. This enables changing ROMs during qualifications without losing test coverage data already captured. Checkpoints may move in the address space freely between ROM revisions. The present systems and methods are not tied to physical addresses as in other coverage mechanisms. The present invention measures execution order, not execution position.

Test plans for software or firmware may use “pass mode signatures” that provide additional evidence that a test passed successfully. The present invention facilitates faster regression testing, and other testing. One manner of testing code functionality in accordance with the present invention is to find an archived signature of known good working software. As new code needs to be tested, the tests executed by the known working software to generate the archived signatures are run, and the signatures of the new and old code are compared. If the new run creates the same signature, the new code successfully passes a preliminary regression test.

The present systems and methods may be extended to chassis code debugging. As is known in the art, chassis code debugging is a process that involves identifying the location of where and when a problem occurred in code execution by following the process flow of a generated status and progress messages output during normal execution of code such as during boot of a system. The output may be mapped back to source code where it is generated, giving a software engineer some insight into the section of code in which a problem occurred. Checkpoint signatures provide an additional level of detail about what is happening within the firmware of a system under test, separate from, or in addition to, chassis code debugging.

Checkpoint signatures may provide a “digitization model” of code which facilitates taking sample points in code under development to identify software quality. Likening this digitization model to computer aided animation where a three-dimensional object is mapped into a computer to model the object, then the computer may rotate and otherwise manipulate this model, the more points that are digitized, the more accurate the representation in the computer. Similarly, the present invention models code or software execution in such a manner that the more checkpoints that are mapped, the more accurate or complete the signature.

Checkpoint signatures also provide insight into loaded modules in debugging firmware code. Since the present inventive systems and methods do not rely on a utilities subsystem or the like, the present invention is useful in firmware debugging from reset through OS initiation, even before chassis codes become available, or when stack initialization is not complete. When a computer system boots, it does not have memory, a stack, an OS, or input/output (I/O) functionality. The present invention enables gathering of code coverage data for analysis before a system is ready to start outputting data.

Risk analysis employing the present invention may be used to weigh the validity of fixing bugs and adding new features by facilitating projections as to how long the qualification process for bug fixes or feature additions will take. To this end, the present systems and methods may provide an ability to measure what tests need to be run for debugging fixes and added features, particularly in firmware.

An enterprise often has different products sharing a common code base, by using checkpoint signatures, developers who are responsible for moving features from one platform to another platform may use the signatures to verify that migration software mergers have been properly carried out. This verification might include insuring that all the proper source files and all the proper revisions of those source files have been migrated.

By tracking bugs to actual tests, and having the ability to identify what software modules are utilized by those tests, the present invention provides functionality to tie bugs with software modules, and generate metrics on code complexity and areas of weakness in the software/firmware. Using test coverage, analyzing what features are being tested when specific tests are run, the present invention provides knowledge as to the what modules are executing when code is run. This information may be used to map what tests need to be run if changes are made to the mapped modules. So the present invention provides a two-way door that gives insight into what needs to be tested if something is changed as well as what code tests are actually testing.

Advantageously, the present systems and methods are non-intrusive to the software/firmware and are useful in system diagnostics. According to embodiments of the present invention, the checkpoints are extracted and externally logged or captured. Also, off-line processing of signatures, may be used to detect additional problems with the health of a computer or firmware system. Off-line processing may look at the signatures comparing them to known good and/or known bad signatures of executing code, and detect errors, notify operators, or the like.

The present invention also facilitates smoke tests in system diagnostics. An enterprise's external partners often need binaries early in a development process for their own testing purposes. In accordance with the present invention, certain groups of tests and common comparisons with archived signatures may be used to provide a binary that is distributed early. Such smoke tests may be performed by validation of real-time signatures, by comparing generated signatures to known passing signatures. If problems are found, code may be analyzed further as needed, before proceeding with early distribution.

Advantageously use of checkpoint signatures does not remove any of the functionality of existing test tools. Checkpoint signatures integrates with existing technology and techniques and provides additional information at little or no cost. Another advantage of the present inventive systems and methods is that by being able to compare signatures there is no need to compare user interface information. By using checkpoint signatures a developer or technician may measure internal values related to code execution and need not rely on the limited resources of system interface reported information.

Use of the present invention may be expanded beyond code related to embedded systems. However, by implementing the present system to test an embedded system, a tool is provided that is useful “up the chain”. Code coverage of all of the layers of a system, the OS, boot loaders and the like, may be analyzed using the present invention.

Turning to FIG. 2, flow of a simplified example program 200 adapted to output test checkpoint signatures is illustrated. By passing different data through the simplified flow chart of FIG. 2 not only is the mechanism for generation of different checkpoint signatures illustrated, but also how different code paths may be mapped is shown. Execution of the code starts at function beginning 201 with the passing of an amount or value. Initialization of the code takes place at 202. Upon completion of initialization at 202 a first checkpoint, checkpoint “A” is emitted at 203. Typically, the present systems and methods uses numbers for checkpoints, thereby providing an infinite number of checkpoints. However, other designations may be used, preferably designations that would act as a unique identifier. In FIG. 2, for the sake of clarity, letters are used to denote checkpoints. The first decision that software 200 makes is to determine at 204 if the amount that has been passed into the function at 204 is greater than ten. There are two paths, 205 and 206 out of decision block 204. If the value passed in at 201 is greater than ten, yes-path 205 is taken; if the value is less than or equal to ten, decision block 204 is exited by no-path 206 and checkpoint “B” is emitted at 207. No-path 206 does not provide any other decisions, so along path 206 program 200 terminates at 208 indicating an input value of less than or equal to ten. If at 204 it is determined that the input value passed at 201 is greater than ten, yes-path 205 is taken and a “C” checkpoint is emitted at 209. An additional comparison is made at decision block 210 to determine if the input value is greater than twenty. If the input value is greater than twenty, decision block 210 is exited via yes-path 211; and if the input value is less than or equal to twenty, decision block 210 is exited via no-path 212. Along no-path 212 a “D” checkpoint is emitted at 213, indicating that the input amount is less than or equal to twenty before function 200 ends at 208. Along yes-path 211 an “E” checkpoint is emitted at 214, indicating that the input amount is greater than twenty.

To instrument function 200 a choice may be made to place checkpoint 203 at the very beginning, right after initialization 202, as an indication function 200 is executing. Therefore, in all cases checkpoint “A” (203) should be reached. After the first decision, at 204 two checkpoints are inserted, one on each side of the decision. As noted above, if the input value is less than or equal to ten, a “B” will be output, and if the input value is greater than ten, “C” will be output. A second determination, whether the input value is greater than twenty is made at 210. If the value is less than or equal to twenty, a “D” checkpoint is output. If the value is greater than twenty, an “E” checkpoint is output. With five different checkpoints inserted in the code, “A” through “E”, the flow chart of FIG. 2 will be used below to demonstratively generate signatures of code execution paths for different values.

Starting with a value of five as a first example, the function begins at 201, data is initialized at 202, and at 203 on “A” is emitted. At 204 it is determined that the value is less than or equal to ten, so path 206 is taken. At 207 a “B” checkpoint is emitted and function 200 ends at 208. Thus, an input value of five generates the checkpoint signature AB in program 200.

Passing in a value of fifteen at 201, function 200 again starts and following initialization at 202, checkpoint “A” is output to a logging system. At 204 it is determined that fifteen is greater than ten. Therefore, yes-path 205 is taken out of block 204 resulting in a “C” checkpoint issuing. At 210 it is determined that fifteen is not greater than twenty. Resultantly, no-path 212 is taken and a “D” checkpoint is emitted at 213 before function 200 ends at 208. Thus, the signature for function 200 with an input value of fifteen is ACD.

The final code path through function 200 may be followed by passing in a value greater than twenty. Using the value twenty-five, function 200 begins at 201 and initialization occurs at 202 to output an “A” checkpoint. The first decision at 204 is that twenty-five is greater than ten, so block 204 is exited via yes-path 205, emitting checkpoint “C” at 209. The second comparison at 210 indicates that twenty-five is greater than twenty, so 210 is exited via yes-path 211 which will cause an “E” checkpoint to be output. Then function 200 is exited at 208. So the signature for function 200 with an input value of twenty-five is an execution path of ACE.

So with three different execution values or parameters passed into function 200, three different code paths, all generating different signatures result. These output signatures would indicate that function 200 successfully executes. Looking at the sub-components of the streams, it may be determined which execution path was executed for each input value.

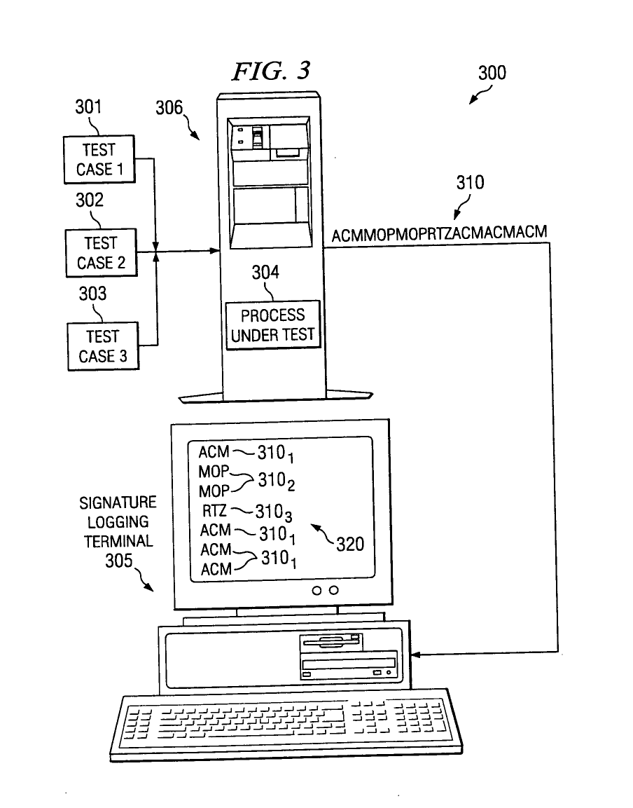

FIG. 3 is a diagrammatic illustration of a test system 300 employing an embodiment of the present invention. To implement the present invention, points in code 304 that is being instrumented for placement of checkpoints are identified. This selection is largely at the user's discretion because software or other code is typically generic for the purposes of the present invention. In other words, anytime there is a decision that is made by the code, or anytime a chain of command or chain of control is transferred to a function or to another module, a relatively unique checkpoint may be placed to confirm the decision, transfer or the like. A developer might instrument code so that code of particular interest is instrumented with a unique identifier signature that is readily tied back to that specific instance of the code. Specific checkpoints may execute multiple times, and checkpoints may also only execute in a single place.

The routine that outputs checkpoint may be a function that is written into the source code under test, or it may be a mechanism that takes advantage of a specific microprocessor architecture. For example, in a Reduced Instruction Set Computer (RISC) processor based system, an instruction that generates a bus transaction that may be captured by a logic analyzer or the like, and act on that signal, may be used. Whereas software executes very quickly, and depending on how often or how frequently checkpoints will be executed, the bandwidth needed between an external logging/capture system and the system under test may preferably be fairly high in order to capture all the data. One avenue of implementation is inclusion of an additional hardware register to which the microprocessor may write the resulting binary numbers or other designations. The register may output those numbers or designations via a serial port, Ethernet port or the like as a stream to be captured by an external logging/capture system 305.

When code 304 is executed by system 306, as each checkpoint is encountered, an individual unique checkpoint ID is output by system 306 as stream 310 and captured by external system 305. External system 305 sequentially lists and logs checkpoints. Whatever tests are desired may be run on system under test 306, a single test (301, 302 or 303) or a suite of different tests 301, 302 and 303. The more tests that are run, the more software checkpoints that will be encountered and, the bigger log or stream 310, to generate unique signature 320.

Raw data stream 310 from an initial run may not be very informative, because data may not be available to compare to the signatures. However, during code design certain checkpoints may have been inserted to elicit specific signatures, or a developer might know that certain functions generate specific signatures. The developer may look through the code, comparing it to the signatures to ascertain whether component pieces, functions and/or sections of code executed. The signature is being generated by the software as it is executed. As each checkpoint is reached a corresponding checkpoint, represented by a single letter in FIG. 3, is output. Stream 310 after a test has been executed might in the example of FIG. 3 using letters in place of checkpoints, be ACMMOPMOPRTZACMACMACM. Individual components of the signature may be broken down into known functions through recognition of subsignatures 301₁-301₃ of functions that are known to have been instrumented in the code. For example, ACM stream, or subsignature 301₁, may indicate that computer 306 is idle and is waiting on user input. MOP subsignature 301₂, may be generated when the user is entering a command. In this case the test may have actually entered a user command as a part of the test. The next subsignature is the same, MOP, which might indicate reentry of the same command or entry of a different command. The next subsignature, RTZ (301₃), is generated when computer 206 recognizes the command that the user has entered at the previous MOP subsignature, and has begun to process the command, using a function that was instrumented using a path through the code indicated by the subsignature RTZ. At that point the test was completed in the example of FIG. 3 resulting in generation the next three blocks, ACM, ACM, ACM, indicating that computer 306 has gone back to an idle state.

Once code has been tested and the code functions properly, sections of the output stream may be captured and stored as archived signatures. These archived signatures may be used as reference signatures for later testing and qualification as discussed above. Once these references are available, signatures generated by tests of code changes may be compared with the referenced signatures to localize problems with the code change.

Turning to FIG. 4 method embodiment 400 for migrating code from a source platform to a target platform is flowcharted. For example, if a source platform has a feature that is desired for a target platform, software for the feature may be run on the source platform and a signature generated. At 401 the code to be migrated is instrumented with checkpoints that may be provided by tests run during execution of code and the instrumented code is run on the source platform. These tests output checkpoints to generate a signature at 402. Alternatively, an archival signature may be recalled at 403, if available, rather than running the code and generating a signature at 401 and 402. At 404 the desired code is migrated to the target platform. At 405, following compilation of the code on the target platform, the same tests are instrumented in the code and run during execution of the code on the target platform to generate a new signature at 406. At 407 the new signature from 406 is compared to the original signature, from 402, or the archived signature from 403. The comparison may be used to ensure the merge was correctly carried out. The signature from the run on the target platform should be the same as the signature from the initial run on the source platform or the archived signature, with possibly only minor variations.

1. A method for testing code comprising:
instrumenting code to output checkpoints at selected points during execution of said code on a processor device to derive individual test checkpoints; and
generating a signature using said checkpoints.

2. The method of claim 1 wherein said checkpoints comprising said signature are arranged in an order of execution of functions associated with said checkpoints.

3. The method of claim 2 further comprising comparing said signature against an expected signature for said code.

4. The method of claim 4 wherein said comparing comprises comparing order of execution of said functions of said code.

5. The method of claim 4 wherein said comparing is carried out offline.

6. The method of claim 1 further comprising repeating said execution of the instrumented code and said generating on a second processor device, commonly configured to first said processor device.

7. The method of claim 6 further comprising comparing signatures, from execution of said code on each of said processor devices, against each other.

8. The method of claim 1 further comprising:
instrumenting a successive version of said code for execution on said processor device to derive a successive stream of test checkpoints;
generating a successive signature using said successive checkpoints; and
comparing said successive signature against first said signature.

9. The method of claim 8 wherein said checkpoints comprising said first said signature and said successive signature are arranged in an order of functions associated with said checkpoints.

10. The method of claim 1 further comprising:
instrumenting a successive version of said code for execution on a second processor device, commonly configured with first said processor device, to derive a second stream of test checkpoints;
generating a successive signature using said successive checkpoints; and
comparing said successive signature against said signature.

11. The method of claim 10 wherein said checkpoints comprising said first signature and said successive signature are arranged in an order of execution of said functions associated with said checkpoints.

12. The method of claim 1 further comprising:
comparing said signature against an archived signature for said code.

13. The method of claim 12 further comprising:
detecting, by said comparing step, modifications to said code.

14. The method of claim 12 further comprising:
debugging said code based on differences in said signature and said archived signature.

15. The method of claim 1 further comprising:
identifying said code from said signature.

16. The method of claim 1 further comprising:
identifying a function of said code from a portion of said signature.

17. The method of claim 16 further comprising:
mapping a function of said code by placement of at least one of said checkpoints in conjunction with said function.

18. The method of claim 17 wherein said instrumenting further comprises placing one checkpoint before said function and another checkpoint after said function.

19. The method of claim 17 further comprising:
determining code functions executed by said processing device by identifying output of checkpoints placed in conjunction with said functions.

20. The method of claim 19 further comprising:
deriving execution paths of said code from said signature through order of execution of said functions.

21. The method of claim 17 further comprising:
detecting an error in execution of said code by identifying output checkpoints placed in conjunction with an error path function of said code.

22. The method of claim 1 further comprising:
archiving said signature;
merging said instrumented code to a second processor platform;
executing said instrumented code on said second processor platform to derive a second stream of individual test checkpoints;
generating a second signature using said second stream of checkpoints; and
comparing said second signature against said archived signature.

23. The method of claim 22 wherein said checkpoints comprising said archived signature and said second signature are arranged in an order of execution of said tests.

24. The method of claim 1 wherein said processor device is a computer.

25. The method of claim 1 wherein said processor device is a simulator.

26. A system for testing code comprising:
an under test processor based device executing said code, wherein said code is instrumented to output checkpoints at selected points during execution, said processor device adapted to output said checkpoints in a stream; and
an external processor device receiving said output checkpoint stream and deriving a checkpoint signature for execution of said code from said stream.

27. The system of claim 27 wherein firmware of said under test processor based system provides said code.

28. The system of claim 27 wherein said under test processor based device executes said code as part of a simulation of another processor based device.

29. A method for merging code from a source processor platform to a target processor platform said method comprising:
implementing said code to output checkpoints at selected points during execution of said code on a target processor platform to derive a stream of individual test checkpoints;
generating an ordered signature using said checkpoints; and
comparing said signature against an archived signature derived from successful execution of said code on a source processor platform.
